(19) United States
(12) Patent Application Publication
(10) Pub. No.: US 2011/0166978 A1
(43) Pub. Date: Jul. 7, 2011

(54) Method, apparatus and system for financial planning incorporating calculated health costs and health-based longevity

(75) Inventor: Renato Mastrogiovanni, Topsfield, MA (US)

(73) Assignee: HealthView Services, Inc.

(21) Appl. No.: 12/655,591

(22) Filed: Jan. 4, 2010

(51) Int. Cl. G06Q 40/00

(52) U.S. Cl. 705/35

(57) ABSTRACT

A financial management tool includes calculated health care costs and health-based longevity to provide information to retirees to be able to calculate the amount of money that needs to be saved to cover retirement expenditures.

### FIELD OF THE INVENTION

This invention relates to financial planning tools and more particularly to the incorporation of calculated health costs and longevity based on an individual's health.

### BACKGROUND OF THE INVENTION

In the financial planning process, financial services available from a large number of companies include comprehensive planning tools that aid individuals in planning for retirement. These comprehensive planning tools such as those available from EISI's Naviplan provide an individual with ways of planning for the individual's retirement based on the individual's personal financial profile. Typically these comprehensive planning tools take into account contributing factors, such as fixed and variable living expenses such as mortgage, food, utilities, clothing, vacation expenses, charity donations, and taxes. Typically these tools specify a retirement date and project available funds by taking into account various income sources as well as expenses throughout the retirement period.

These comprehensive tools may factor in retirement income generated from sources such as savings, Social Security, a pension, veterans benefits as well as employment during retirement.

All of these comprehensive tools project available cash or income while making adjustments for variables such as inflation and the rate of return, allowing an investment counselor to determine the financial status of their client

The problem with such comprehensive planning tools is that they fail to take into account out of pocket health care costs and expected longevity based on a personal health profile for each individual. Up until the present time, there has been no way of calculating an investors future out of pocket health care costs based on a customized personal medical profile and expected lifespan. As medical expenses will be the single largest expense Americans will face in retirement, it is critically important that financial planners have an accurate and consistent means of incorporating health care expenses and life span into the retirement planning process. Moreover, traditional retirement planning tools do not incorporate longevity statistics based on the health of the individual.

It is noted above that the cost of heath care is the single largest financial burden faced in retirement. Over the last few decades health care costs have risen two to three times faster than inflation. Looking forward, the cost of medical care is projected to increase by as much as 15% annually. As a result, a 65 year old healthy person living to an average 20 year life expectancy will need perhaps $100,000 to $150,000 to cover health care costs during retirement.

In addition, the actual health care cost could even be higher if health care costs increase faster than projected. Moreover, if one becomes ill or one lives beyond the average life expectancy, one might need to be provided with nursing home care, the current cost of which can exceed $90,000 a year in some regions of the country.

With respect to commonly available insurance, it is noted that Medicare Part A covers only half of health care expenses, and private insurance is often too costly and does not always address healthcare needs. These realities are causing forward looking consumers to assess the impact of health care expenses on their financial futures so that they can intelligently plan.

Thus, in the past there has not been a retirement planning tool that incorporates into individual plans personalized actuarial based longevity, as well as a calculation of health care expenses based on the health of the individual.

### SUMMARY OF INVENTION

In order to overcome the shortcomings described above, a financial management tool is provided which in addition to the usual financial profiling also considers an individual's health in order to project their heath care expenses during retirement. The subject tool will also includes longevity calculations based on the personal health profile of each individual.

It is noted that financial advisors arbitrarily project lifespan and in many, if not majority of cases, simply ignore health care expenses. As a result, there are health care expenses which are unaccounted for during the planning process that affect an individual's retirement.

The subject system provides a tool involving a method of calculating personal health care expenses and personalized longevity based on the particular medical history of the individual. This permits taking into account projected lifespan based on, amongst other things, health factors. Thus, if a person has high blood pressure or cancer; or is a smoker, the subject system projects a specific longevity as opposed to an average longevity. Moreover, these self-same considerations are utilized to project out annual health care costs during retirement.

With these two calculated inputs one can utilize the available comprehensive planning tools, and the subject system, to provide a comprehensive program tailored to the individual.

In one embodiment, the system incorporates a questionnaire or profiling system that takes necessary items into account to calculate health care costs and longevity. This is then plugged into a database, in which the costs are broken down into different categories such as out-of-pocket expenses, insurance premiums, general medical expenses and eye, ear and dental expenses. The database for the individual is also broken down into specific disease states, such as heart disease, cancer, high blood pressure, cholesterol and the like. One embodiment of the system utilizes a 25 health care questionnaire. The subject tool provides a report which calculates the projected amount of money that one will need to save in the present in order to cover future out of pocket health care expenses during retirement, all based on the individuals health history and expected lifespan. In one embodiment, the system takes the future value of retirement expenses as of the first year of retirement and based on an expected return on savings in retirement as well as the return on savings prior to retirement calculates how much the investor will be required to save today in order to cover future annual medical expenses in retirement.

Also inputted into the program is the current age of the individual, their proposed retirement age, their calculated life expectancy, the health care inflation rate, the expected rate of return prior to retirement, and the expected rate of return during retirement. The result of the financial tool calculation is the amount needed to be saved in order to cover future expenses, including health care costs.

The system is flexible in that one can choose a particular rate of return both prior to retirement and during retirement, and can then enter different retirement dates and to see the difference in the rates of return.

Obviously most individuals would not be as aggressive in their investments during retirement as they are in a pre-retirement period. This can also be reflected in the calculation made by the subject tool. As an example, if one is looking at a growth portfolio on a compounded basis, one may be looking at a 7% rate of return prior to retirement, but for instance a 4% return during retirement.

The important point is that the individual is given the opportunity to choose the rates of return and see what happens to the available funds. The calculation also enables one to project out what additional money needs to be saved per month if one cannot come up with an initial investment.

In summary, the subject tool permits an individual to know what are his or her costs going forward given a health-based prediction of how long the individual is expected to live.

The subject tool therefore incorporates health related information to provide more accurate forecasts and budgeting for the individual.

Moreover, even when the individual is already retired, the subject tool has value in terms of the individual's budget during retirement. Since the subject tool is able to take into account the individual's income and since all costs including health care costs are calculated, the individual can ascertain how long his total savings will last based on lifestyle and potential health care expenses. All future household expenses, including health care, can be projected out at various inflation rates. In addition, expenses other than health care can be scaled down during the retirement period. A hybrid balance sheet incorporating an income statement can be projected in the future value for any selected year in retirement.

Thus, the subject tool provides information necessary to evaluate the individual's current situation whether they are in retirement or planning for retirement. Completing the health care questionnaire begins the calculation of projected health care expenses, projects longevity and budgets, in today's dollars, the projected cash amount for each year of retirement. The result is a complete distribution analysis which shows year by year how the individual's assets are diminishing and when the assets will run out.

The subject tool not only assists individuals in planning for retirement, it can also assist large companies. For instance, firms with over 100,000 employees are in general self-insured and could benefit from the subject tool. Though these companies may employ traditional insurers, such as Blue Cross and Blue Shield, the insurers function simply as record keepers. Should these insurance companies wish to provide other services to their customers, they could add the subject tool to their healthcare platform. For example, they could include a wellness function, or a disease management function based on the reports from the subject tool.

Thus, in addition to record keeping, with the subject tool one can provide the cost impact of either following a doctor's direction or not following it for each individual employee. For instance, the employee could be informed as to the increase in his own health care contributions if he is not leading a healthy lifestyle. The cost in and of itself is an incentive to the employee to enroll in wellness programs which traditional insurer may already provide.

The obvious incentive of following a doctor's instructions is that ones longevity can be increased. Thus, the individual has both a cost incentive to improve his or her health condition and a longevity incentive. It is noted that by following a doctor's instructions, the individual can save in terms of his premiums. With the individual company typically picking up 75% of the employee health cost, this incentive to wellness could greatly impact the company's bottom line.

A second application for the subject tool is to provide an incentive for employees to opt for a high deductible policy. The high deductible policy saves health care costs, not only for the individual, but also for the company.

For instance, an individual who is 28 years old and healthy need perhaps only need a $2,000 deductible, as opposed to the usual $200 deductible which is normally chosen.

By inducing the employee to take the $2,000 deductible, if appropriate, then the out-of-pocket cost to the individual is significant and these savings could be applied to a health savings account tax-free. Thus, the individual can not only save on his monthly premium, but he can put the savings away on a tax free basis.

While the present adoption rate of high deductible policies is less than 5%, the subject tool could provide the necessary inducement to the appropriate employees to opt for the high deductible policy. A possible result could be a saving of approximately 20% a year on company health costs.

In summary, the subject system informs the individual of his options, calculates health care costs in his retirement planning, and gives him health-based longevity information that enables the individual to develop a comprehensive retirement plan. In other applications, the subject tool encourages high deductible policy enrollment for those for whom it is appropriate and supports wellness programs.

### BRIEF DESCRIPTION OF THE DRAWINGS

These and other features of the subject invention will be better understood in connection with the Detailed Description, in conjunction with the Drawings, of which:

FIG. 1 is a diagrammatic illustration of the subject financial management tool utilizing health-based life expectancy and calculated health care expense to provide a display of cost of living versus available assets;

FIG. 2 is a block diagram of the system of FIG. 1, in which the results of a health risk analysis questionnaire are provided to project health care costs and to provide health-based lifespan estimates;

FIG. 3 is a diagrammatic illustration of the health care questionnaire utilized in the subject invention, which incorporates basic information about the individual, lifestyle and medical history to provide a health risk analysis that results in a personalized health expense financial management tool that calculates the savings or income needed to cover out-of-pocket costs during retirement;

FIG. 4 is a pie chart showing projected out-of-pocket health care expenses broken up into dental, co-pays and premiums;

FIG. 5 is a graph showing expense growth over the course of retirement years for dental, co-pays and premiums;

FIG. 6 is a graph showing the cost of waiting to enter into a retirement program based on current assets available versus costs in four years;

FIG. 7 is a bar chart showing estimated medical costs in retirement for both the client and the client's partner over five year retirement periods;

FIG. 8 is a diagrammatic illustration of the estimated medical costs in retirement, which compares savings needed to cover medical expenses in retirement versus actual medical expenses in retirement, showing the advantage of early investing; and,

FIGS. 9A-9E are flow charts showing the operation of the subject system.

### DETAILED DESCRIPTION

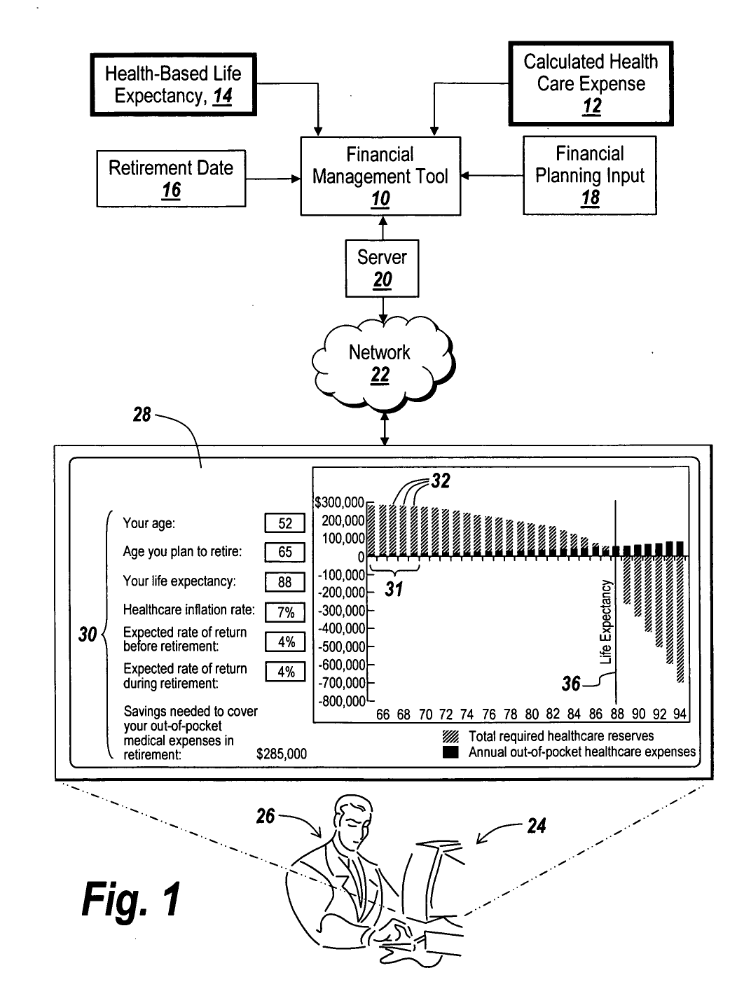

Referring now to FIG. 1, the subject financial management tool 10 is provided with both calculated health care expense 12 and health-based life expectancy 14. This takes into account health-based information to assist in financial management during retirement. Also, as an input to the financial management tool, is a selected retirement date 16 as well as a financial planning input 18. Note that the financial management tool incorporates a processor for running algorithms that provides the calculations necessary for the subject invention, as well as data storage.

The financial management tool 10 is coupled by a server 20 to a network 22 that may include the internt or some wireless communications vehicle, with the input to the financial management tool being from a terminal 24 operated by an individual 26. Here terminal 24 has a display 28 and enables input of relevant individual data in fields in the tool's data storage. The display of health-related information enables the individual to plan for retirement.

As can be seen on display 28, there are a number of fields 30 respectively relating to the age of the individual, the age that the individual plans to retire, the calculated life expectancy of the individual, the health care inflation rate, the expected rate of return before retirement, and the respected rate of return during retirement.

As a result of the operation of the subject tool a calculation is made to as the savings needed to cover the out-of-pocket medical expense portion of the expenses associated with retirement.

What is shown in the graph to the right of the display are the out-of-pocket medical expenses per year in retirement based on the information that has been provided in the dialog boxes to the left.

Assuming that an amount of savings needed to cover out-of-pocket medical expenses in retirement for a person age 52 who plans to retire at 65 and has a life expectancy of 88, what is displayed by columns 32 are the total required health care reserves. The shaded portions 34 show the annual out-of-pocket health care expenses. It is noted that the life expectancy 36 is derived based on not only average actuarial tables, but also actuarial tables taking into account the particular individual's health status.

As can be seen at age 65, in one example the amount of assets available is $285,000. This sum is decreased by the total required health care cost, with the out-of-pocket health care expenses increasing during the retirement years. What can be clearly seen from this chart is that the health care reserves are completely depleted at the calculated date of death.

Thus, the chart indicates that given all the health care information incorporated into the calculation, at the time of death one has completely depleted ones health care reserves. This is based upon initial savings, the health care inflation rate, and expected rate of return before retirement and expected rate of return during retirement.

This tool can be exercised by the individual by selecting values of the indicated variables, for example to compare the financial implications of retiring at one age as opposed to another.

One can also evaluate ones financial situation by varying the rates of return, both post-retirement and pre-retirement.

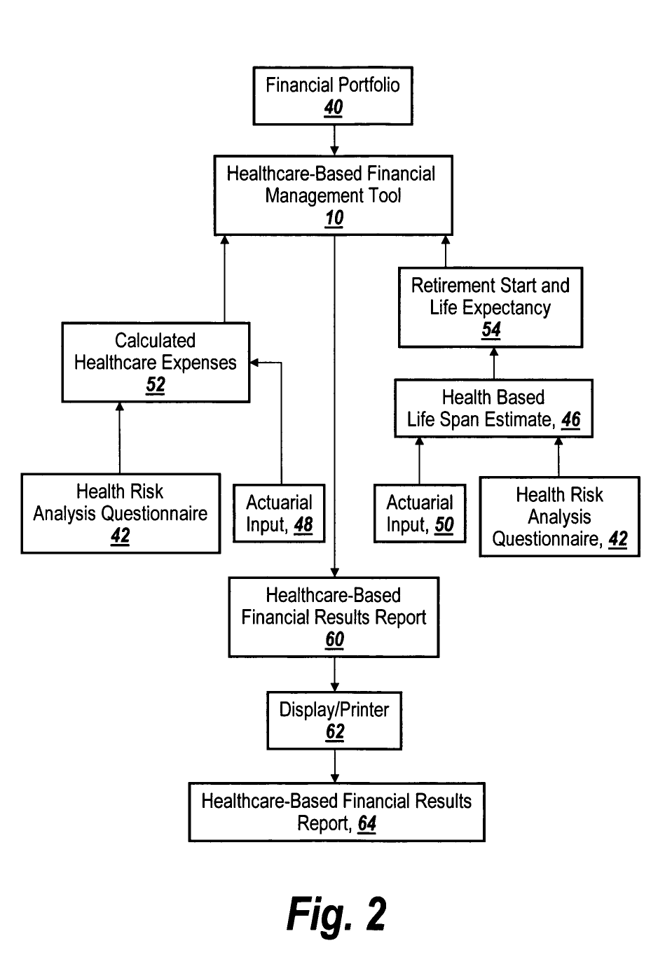

Referring to FIG. 2, financial management tool 10 has its financial planning input from a financial portfolio 40 in which various investment portfolio scenarios can be entered into tool 10.

Most important, with respect to this financial planning tool, are the health care based initiatives engendered by the completion of the health risk analysis questionnaire 42, which is used both to provide information about and to project health care costs as illustrated at 44, and to deliver a health-based life plan estimate 46. There is an actuarial input 48 to enable the projected health care costs to be calculated at 52, as well as an actuarial input 50 to be able to provide for a health-based life span estimate.

The projected health care costs are the health care expenses calculated at 52, whereas the health-based life span estimate 46 is utilized to populate a module 54 that defines the retirement start date and the life expectancy of the individual.

As shown, a health care based financial results report 60 is supplied to a display or printer 62 from which health care based financial reports can be viewed as illustrated at 64.

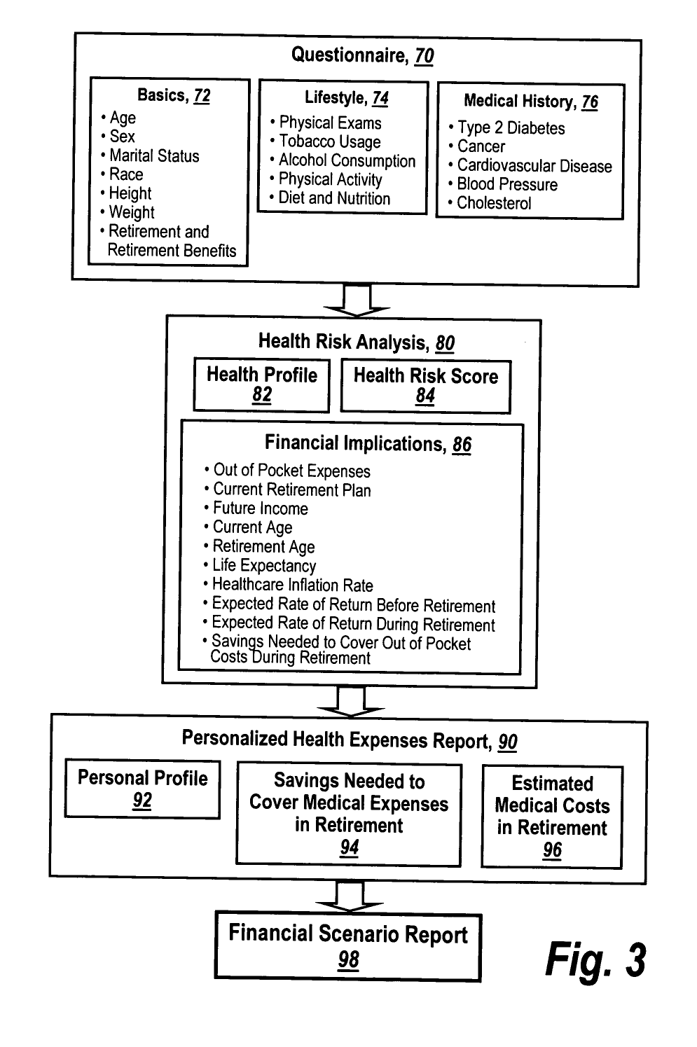

Key to the subject invention is the health care questionnaire shown in FIG. 3, designated by reference character 70. Here the health care questionnaire 72 incorporates basic information such as age, sex, marital status, race, height, weight and answers to types of retirement plans and retirement benefits. The questionnaire also includes a lifestyles portion 74 that incorporates the result of physical exams, tobacco usage, alcohol consumption, physical activity, and diet and nutrition.

The questionnaire also includes a medical history section 76 that includes medical indicators, such as type 2 diabetes, cancer, cardiovascular disease, blood pressure, and cholesterol numbers.

The result of the questionnaire is applied to a health care risk analysis module 80 that includes a health profile 82 generated from questionnaire 70, as well as a health risk score 84.

The health risk analysis creates the financial implications 84 so as to provide entry into a financial plan for instance out-of-pocket health care expenses.

Module 80 having calculated the various financial implications outputs a personalized health expenses report 90, which includes a personal profile 92, the savings needed to cover medical expenses in retirement 94, and the estimated medical costs in retirement 96. These implications are contained in a final financial scenario report 98.

It is thus important for the individual planning for retirement to be able to know what amount to set aside for retirement by taking into account not only the usual financial analysis tool outputs, but also modification of these outputs that account the health of the individual.

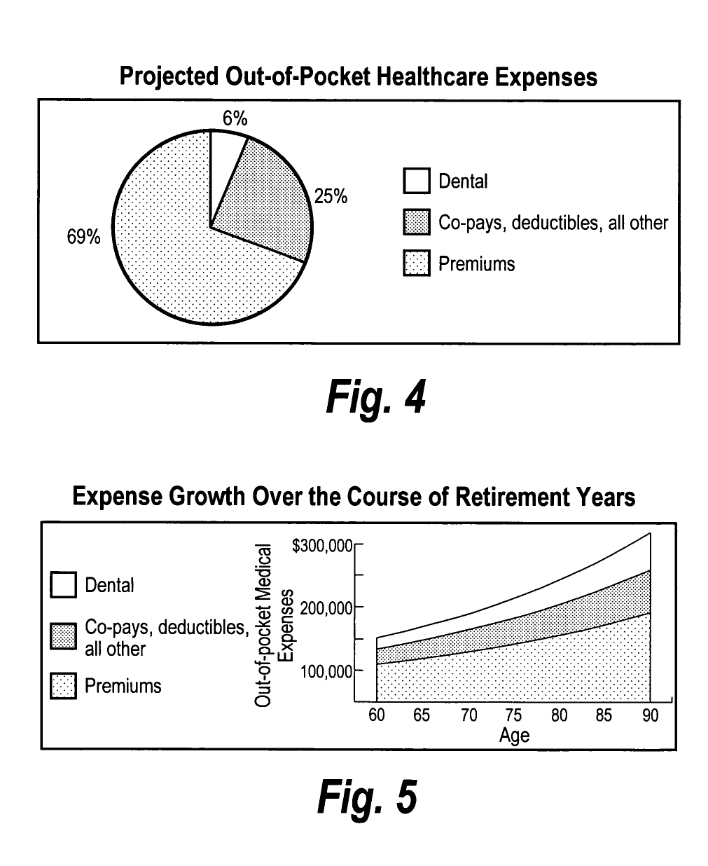

Referring to FIG. 4 as can be seen from the pie chart, typical projected out-of-pocket health care expenses are 69% due to premiums, 25% due to co-pays, deductibles and all other expenses, and about 6% due to dental costs.

Referring to FIG. 5, these projected health care expenses grow over the course of retirement years. For example, the combined dental, co-pay and premium cost at for instance age 60 of $150,000 balloons to over $300,000 if the individual lives to the age of 90.

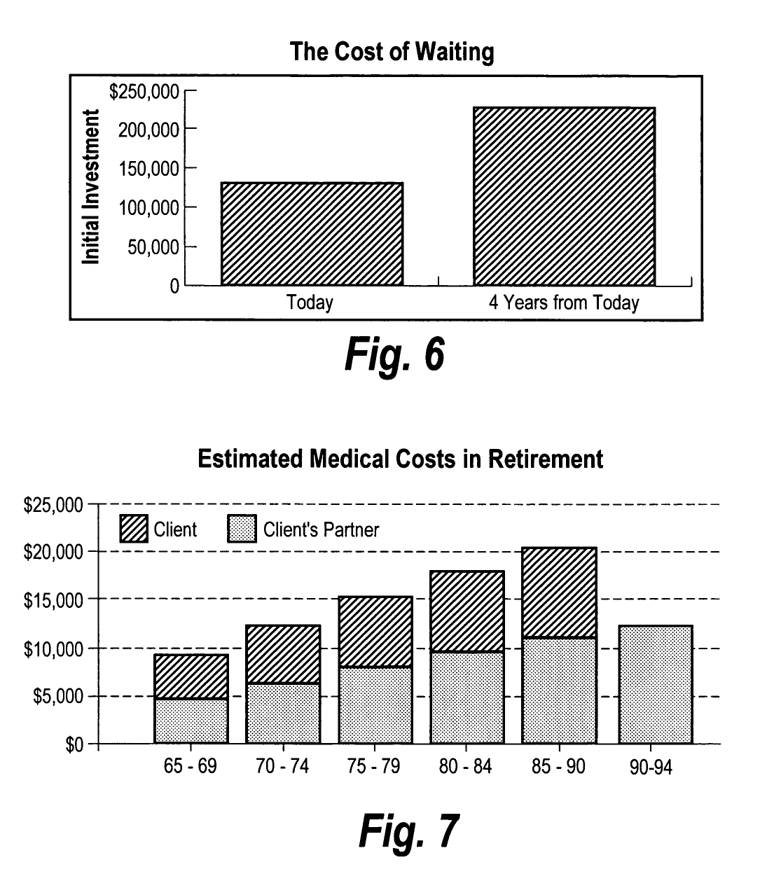

Another useful output of the subject tool is calculating the cost effect of waiting for retirement. As can be seen by the graph in FIG. 6, assuming that one has a current health care cost of $140,000, it can be seen through the use of the subject tool that waiting for 4 years to begin retirement would result in an overall cost increase of approximately $250,000, showing that delay in retirement planning is indeed costly.

Referring to FIG. 7, one of the interesting outputs of the subject system is the ability to provide a visual output of the estimated medical costs in retirement over five year increments and to show the increase in estimated medical costs for either an individual or their partner. Here the estimated medical costs in retirement can be computed on a five year interval based on a combined input from the client and the client's partner. Note, if the client dies at 90 years of age, the client's partner's estimated costs are shown for the following four years.

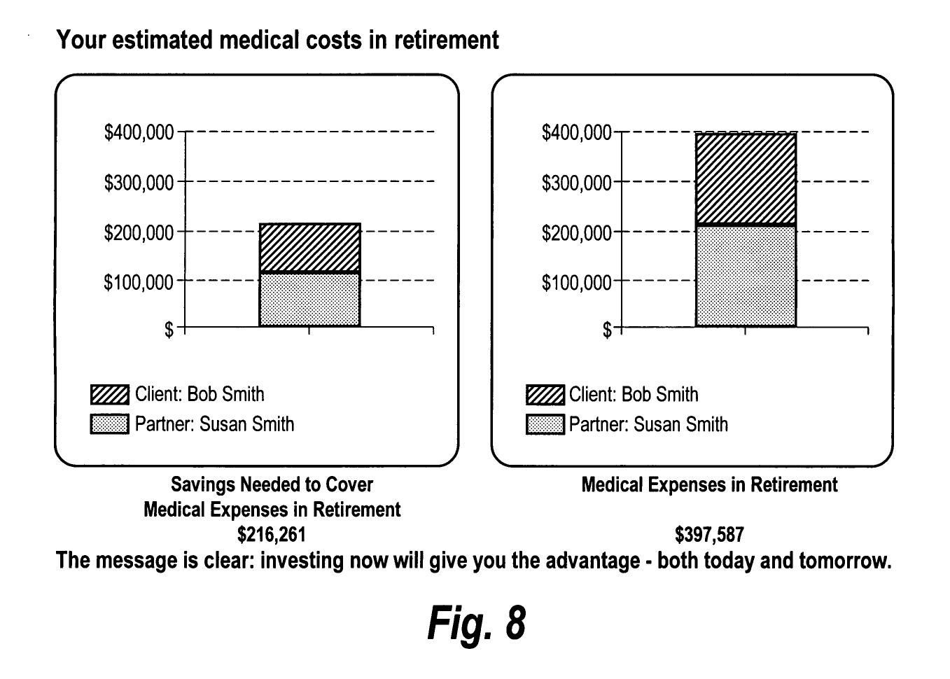

Referring now to FIG. 8, shown are two bar graphs that indicate the savings needed to cover medical expenses in retirement, for instance $216,261 for an individual versus the medical expenses in retirement, which are calculated to total $397,587.

This indicates that early investing is needed to offset the total medical expenses in retirement, which typically exceed the savings necessary to cover these expenses.

In summary, what is provided by the subject financial management tool is an individualized report that calculates the necessary savings needed to cover medical expenses during one's retirement years. Since these medical expenses are the most significant expense during retirement, providing an individual with a calculation of the savings they can determine when to retire and what assets or savings would be required to cover their health care expenses.

What follows are examples of how an individual can benefit from the use of the subject financial management tool.

### EXAMPLE I

As mentioned above, the primary use of the subject tool is to determine how much money one will need to have saved at the point of retirement. Based on the retirement date and the expected return on savings and retirement, the subject system calculates how much savings must be accumulated in order to cover annual medical expenses.

For instance, a particular individual may need $120,000 in savings to cover $120,000 in health care expense. Note that the health care expense is growing at about 5% annually. Assuming $120,000 in savings is required at the point of retirement, the system can calculate from today's date until the retirement date what one would need to save. For instance, one would need $38,000 in the present in order to have $120,000 at the point of retirement to cover the medical expenses.

Since medical expenses are the largest expense during retirement, it is not an expense that can be diminished by living in a smaller house or buying a less expensive car. One does not have these options with health care. Thus, the numbers that are going to have to be addressed are the actual projections based on the individual's health and status.

### EXAMPLE II

Another feature as mentioned before is that if a person needs $38,000 in savings today in order to have access to $120,000 at retirement, the subject system will inform the individual that if they have only $20,000 today, the subject tool will suggest they add an additional $32 per month to reach their goal.

### EXAMPLE III

As noted above, one can choose rates of return and can run “what if” scenarios. For instance, the system can reflect the various financial implications of retiring at 65 years of age or at 67 years of age. The tool can be adjusted to various retirement dates and also on different rates of return during retirement.

If, for instance, one is involved in a growth portfolio on a compounded basis, the individual may be looking at 7% growth. However, during retirement assuming the portfolio is more conservative and goes to purchasing of treasuries, perhaps a 4% rate of return is a more reasonable rate. Thus, the individual gets to choose their potential rates of return and sees what happens to the numbers.

### EXAMPLE IV

As mentioned before, retirees can use the subject tool to calculate the cost going forward into retirement. One of the critical elements is determining an individual's life span. This becomes problematic with age. A healthy 40 year old has a very specific life span whereas a healthy 68 year old life span will be significantly longer than a healthy 40 year old, the extent to which is difficult to judge. Thus, a person that is 68 would need to know their likelihood of living past 80 or 90 and what their health care expenses will look like.

### EXAMPLE V

Retirees generally operate on a budget and must know what the impact their medical cost will have on their budget. Once this calculation is done the question then becomes how long will their money last.

For instance, if the individual is spending between $3,000 and $4,000 a year on vacations that they were hoping to do on an annual basis until they are 75, they may be persuaded by the subject calculations to alter their spending habits. In order to inform the individual, one first has to calculate their health care expenses. Then one has to provide a budget in today's dollars.

For instance if the budget is $30,000 a year for medical expenses, by the end of a 15 year period in which a 3% inflation rate is constant, medical expenses may be over $60,000 a year. It is important for individuals to know these numbers when establishing their budget and the subject tool in determining these adjusted costs. The next budget step is income sources. Assuming that one has a half a million dollars in savings, is going to generate $24,000 out of social security, has a small pension, and could potentially sell his or her house, the subject tool can calculate a distribution analysis on a year by year basis to show how ones assets are dwindling and when they will run out. If one knows that one is going to be living in retirement for 30 years one could be out of money in 20 years. Thus creating a budget that takes into account the health care costs is an exceedingly useful function for the subject tool.

### EXAMPLE VI

As mentioned above, firms with over 100,000 employees are self-insured. The question of raises for employees presents certain problems. For instance, one needs to know whether to give an employee a 5% raise and how much the raise is really worth. With the subject tool the company can quickly plug in a 7% increase in health costs so that in this scenario the employee is being given a 12% raise.

### EXAMPLE VII

The subject tool provides realistic numbers based on a persons health history and other actuarial characteristics and provides disease management and wellness advice. As mentioned above, if an employee can better manage their health care then cost savings can be significantly augmented. For instance, if an individual knows his age and health status, the subject system can output the life span of the individual. It is then possible to calculate the annual cost of health care because the company knows what portion the individual pays for and what portion the company covers. For example, if the individual does not follow a doctor's prescribed plan, instead of living to 78, the life span could be 67. There are associated annual costs for health care for the individual between the present time and age 67 which, for instance, may be different than the annual cost between the present time and 78. With successful coaching information can be provided to the employee as an incentive to take the right action.

For instance, if the individual has type 2 diabetes and does not take care of his condition he may die by the time he is 67 years old. If he takes care of himself properly he may live to 78. Calculations from the subject calculator may indicate that he will be spending $800 a year if he takes care of himself, whereas he may be spending $1,400 if he does not take care of his condition.

What is now presented are a series of flow charts to indicate how the subject calculator operates.

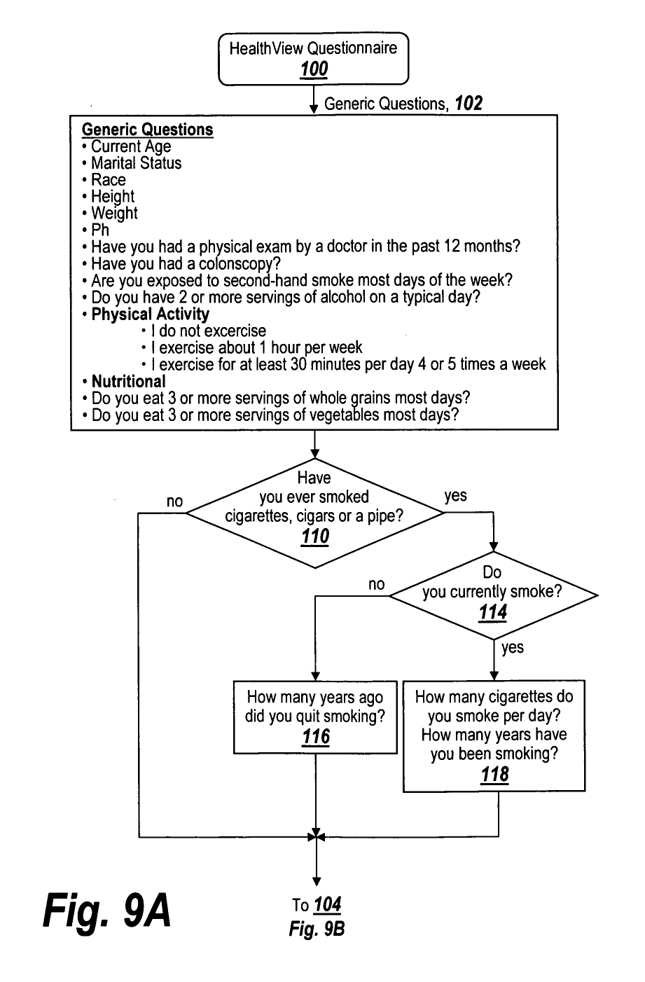

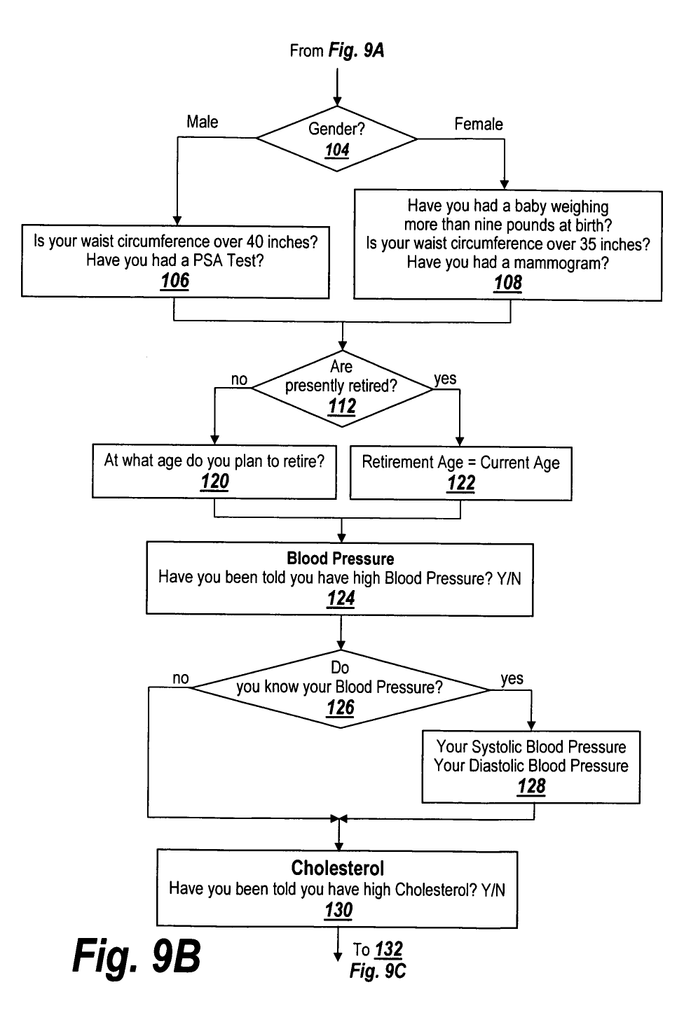

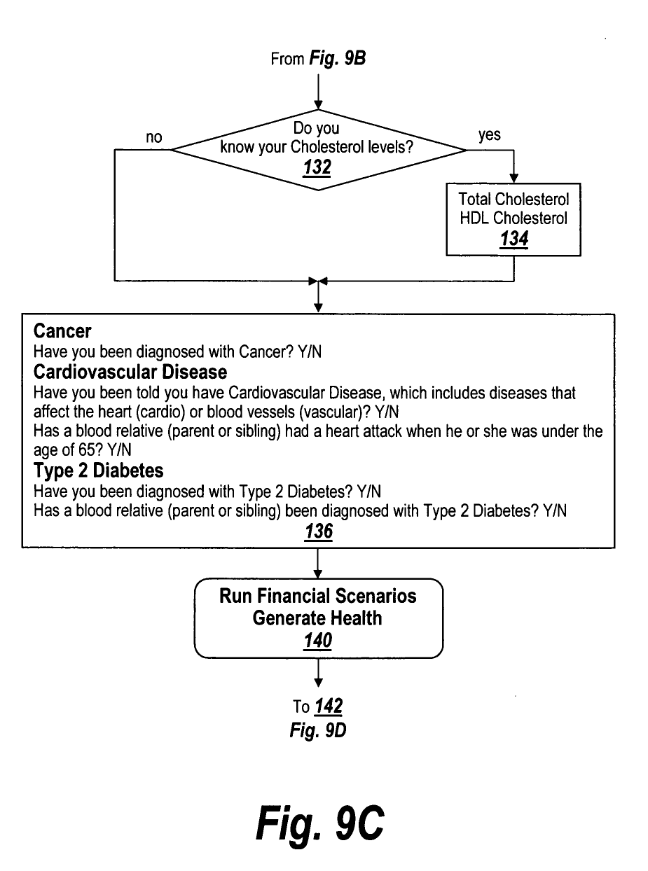

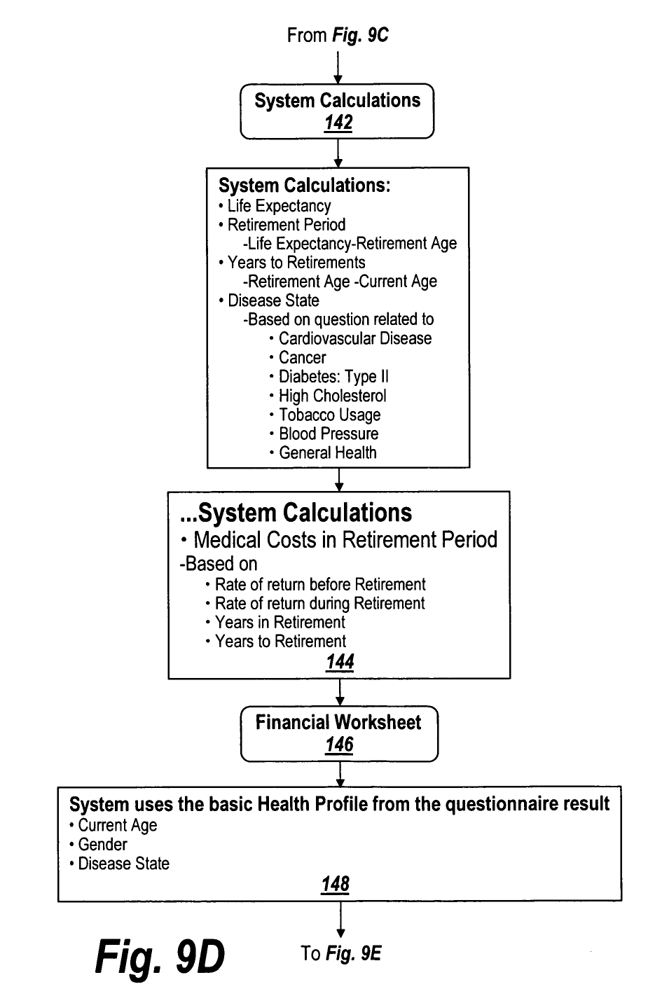

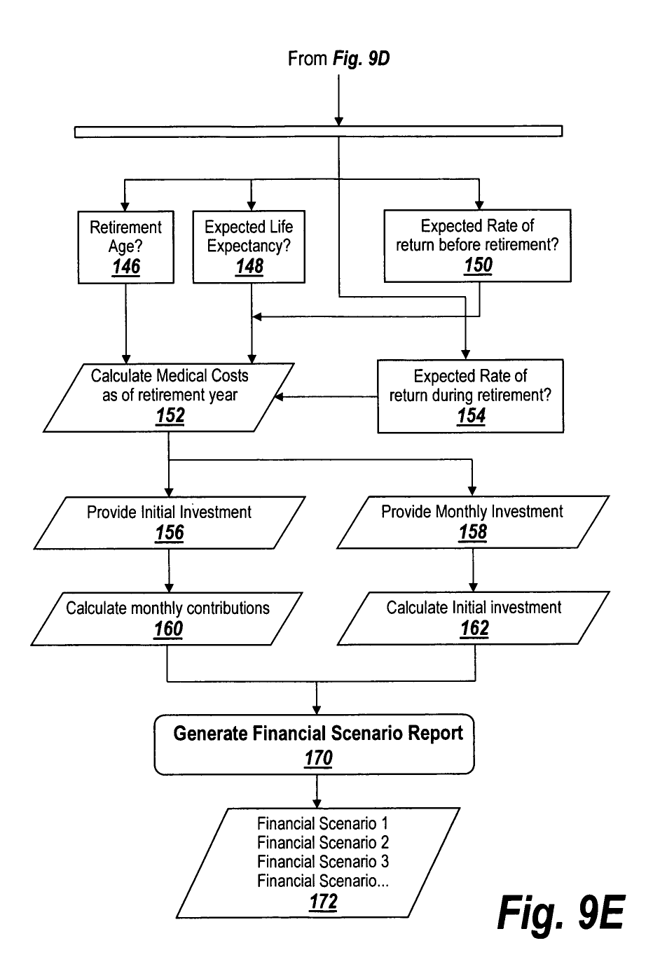

Referring now to FIGS. 9A-9E, the subject process starts with a questionnaire 100 which poses generic questions 102, namely questions such as current age, marital status, race, height, weight, ph, whether you have had physical exam by a doctor in the past 12 months, whether you have had a colonoscopy, how often you are exposed to second-hand smoke, do you have two or more servings of alcohol in a typical day, your level of physical activity, and your eating habits The output of the generic questions is applied to a decision block 104 which then takes the individuals gender into account. If male, then the question is asked as illustrated at 106 “is your waist circumference over 40 inches”, or “have you had a PSA test”. If female, at 108 the question is asked “have you had a baby weighing more than 9 pounds at birth”, “is your waist circumference over 35 inches” and “have you had a mammogram”.

The results are passed to a decision block 110 which poses the question “have you ever smoked cigars, cigarettes or a pipe.” If no, then the answer is passed to decision block 112. If yes then as shown at decision block 114 the question is posed “do you currently smoke”. If no, the question is asked as illustrated at 116 “how many years ago did you quit smoking”. If the answer is yes, the question posed at 118 is “how many cigarettes do you smoke per day and how many years have you been smoking.”

The results of the outputs of blocks 116 and 118 are also applied to decision block 112 which asks the question “are you presently retired.” If the answer is no, then as illustrated at 120 a query is asked as to “what age do you plan to retire.” If yes, then the retirement age is set to ones current age as illustrated at 122.

The results are passed to block 124, which poses the question “have you been told that you have high blood pressure yes or no.” If yes, then as illustrated by block 126 the question is posed “do you know your blood pressure.” If yes, the question is posed at 128 to provide your systolic blood pressure and your diastolic blood pressure.

The outputs of these blocks are passed to a block 130 to ascertain if you have been told that you have high cholesterol, yes or no. The result is passed to decision block 132 which asks the question “do you know your cholesterol levels.” If yes, the question asked at 134 as to what your total cholesterol is and your HDL cholesterol level.

The outputs of these blocks are both sent block 136 which asks the questions relating to disease, namely “have you been diagnosed with cancer yes or no”, “do you have cardiovascular disease, yes or no”, “have you been told that you have cardiovascular disease which includes diseases that affect the heart (cardio) or blood vessels (vascular) yes or no.” Also a question is posed “has a blood relative either parent or sibling had a heart attack when he or she was under the age of 65.” Again an answer yes or no is recorded. Finally the question is asked “have you been diagnosed with type 2 diabetes yes or no”, or “do you have a blood relative, parent or sibling that has been diagnosed with type 2 diabetes yes or no.” The results are passed to a module 140 that runs financial scenarios at 140 which employs system calculations 142. These calculations include for instance life expectancy, retirement period in terms of life expectancy minus retirement age, years to retirement, i.e. retirement age minus current age, disease state based on questions relating to cardiovascular disease, cancer, type 2 diabetes, high cholesterol, tobacco usage, blood pressure and general health. The system calculations as illustrated at 144 result in a calculation of medical costs in the retirement period based on the rate of return before retirement, the rate of return during retirement, years to retirement, and years in retirement.

The output of the system calculations 144 is reflected in a financial worksheet 146 in which the system uses the basic health profile from the questionnaire to indicate current age, gender and disease state as illustrated at 146.

From this financial worksheet one ascertains retirement age as illustrated at 146, expected life expectancy 148 and the expected rate of return before retirement at 150, the outputs of which are referred to a calculator that calculates medical costs as illustrated at 152, which in turn is reflected in the expected rate of return during retirement as illustrated at 154. The calculated medical costs are then inputted to a module 156 that, calculates monthly investment 158, monthly contributions 160 and the initial investment 162. Finally at 170 a financial scenario report is output which provides a number of different financial scenarios based on a number of different variables, all of which are viewed at 172.

### Calculating Healthcare Expense

After the HealthView questionnaire is completed the system determines health status and calculates life expectancy based on Current Age, Gender and Disease state. The information is saved in a database and used in calculating detailed healthcare costs.

The subject system utilizes stored procedures to calculate the medical costs that are required in retirement from actuary tables.

The stored procedure Input parameters are:

Client
Current Age
Gender
Disease State
Expected Life Expectancy
Retirement Age

Spouse (if spouse information collected)
Current Age
Gender
Disease State
Expected Life Expectancy
Retirement Age

Rate of Return before Retirement

Rate of Return during Retirement

Flag to determine if calculation should be at Net Present Value or at Pesent Value as of Retirement Year

The stored procedure returns a data set that is comprised of multiple data tables.

These data tables are used to populate graphs, charts and grids on the reports and forms.

### Processing Steps

The stored procedure performs the following steps:

Get information from Actuary tables to a local data table based on input parameters from retirement age to 100 for client and spouse; the data table being populated with:

ItemRetId

ClientID—Client or spouse

DiseaseState

Gender—M/F

Current Age

Calculated Year

LifeExpectancy

AttainedAge

Total out-of-pocket expenses

Hearing

Vision

Premuims

Dental

TotalCost

Adjusted out-of-pocket expenses

Adjusted Premuims

Adjusted Dental

Adjusted Total Cost

Healthcare Cost in Retirement

HealthcareCost During Retirement

Set ItemRetId as a difference between attained age and retirement age

Calculate adjusted costs to Present Value as of Retirement year for client and spouse using:

HealthcareCostinRetirement

AdjustedPremuims

AdjustedDental

AdjustedTotalCost

Calculate total costs as of Retirement year for client and spouse based on the retirement period (retirement age to expected Life expectancy)

Calculate time to horizon (Retirement age—current age) and calculate investment Required at Net Present Value

Determine the joint retirement period Lowest retirement age to largest life expectancy and determine the three cut-off groups based on the earliest retirement of the two and oldest life expectancy using data related to:

Client

Spouse and Client

Spouse

### Or:

Spouse

Spouse and Client

Client

Calculate Total costs for Client and spouse in retirement periods

Create Output data table that includes annual costs for premiums, out-of-pocket expenses, dental, hearing, vision and total costs for client, spouse and Total for both. Create Output data table that includes annual costs, and average costs at a selected interval during retirement period (default every 5 years) for client, spouse and for both The table includes premiums, dental and out-of-pocket expenses, hearing and vision Create Output data table for client and spouse that displays

Retirement category
Retirement
at retirement year
during retirement

Initial investment

Period—number of years

Slope (%)

The information from the tables provides estimated projected costs closest to actuary tables for graphs and planning tools.

Create an output table with all data collected and processed from the current age to 100 to allow use of the raw data in calculating what if scenario, update grids, charts and graph.

Create a summery output table of cost required for client and spouse

The source code for the subject system is attached as an appendix hereto.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. Apparatus for financial planning, comprising:
a financial management tool for providing as an output the amount of money that an individual needs to save to cover retirement expenditures, said tool adapted to include as an input thereto calculated health care expenses based on the health of the individual and health-based life expectancy based on the health of the individual; and,
a display coupled to said financial management tool for displaying said output.

2. The apparatus of claim 1, and further including as an input to said financial management tool a financial planning input.

3. The apparatus of claim 1, and further including as an input to said financial management tool a retirement date.

4. The apparatus of claim 1, and further including as an input to said financial management tool at least one of the individual's age, the age that the individual plans to retire, the health-based life expectancy of the individual, a health care inflation rate, an expected rate of return before retirement, and the expected rate of return during retirement.

5. The apparatus of claim 4, wherein said financial management tool displays on said display the savings needed to cover the individual's out-of-pocket expenses during retirement.

6. The apparatus of claim 5, wherein said display includes a bar graph indicating by year on the abscissa the total required health care reserves to cover health care costs of the individual in terms of the length of the bar on the ordinate.

7. The apparatus of claim 6, wherein said bar graph includes as a part of a bar the annual out-of-pocket health care expenses.

8. The apparatus of claim 7, and further including on said graph a line intersecting said abscissa that indicates life expectancy.

9. The apparatus of claim 1, and further including a health risk analysis questionnaire, the answer to the questions of said health risk analysis questionnaire being used by said financial management tool to calculate health care expenses.

10. The apparatus of claim 9, and further including an actuarial input coupled to said financial management tool to calculate said health care expenses.

11. The apparatus of claim 9, wherein said financial management tool includes as an input the start of the retirement of the individual and the life expectancy of the individual.

12. The apparatus of claim 11, wherein said life expectancy input is based on a life span estimate having as an input the results of said health risk analysis questionnaire.

13. The apparatus of claim 12, wherein said life span estimate includes an actuarial input.

14. A method for providing an individual with information relating to the amount of savings necessary to cover health care costs in retirement, comprising the step of:
providing the individual with a calculated estimate of the savings necessary to cover health care costs by including in the calculation the individual's health status.

15. The method of claim 14, and further including the step of providing the individual with a health-based longevity estimate, thereby to provide the individual with a projected retirement length between the individual's retirement date and the estimated date of death of the individual.

16. The method of claim 14, wherein the health care status is based on answers to a health care questionnaire.

17. The method of claim 15, wherein the health-based longevity is based on the results of a health care questionnaire.

18. The method of claim 14, wherein the results of the method step are used to calculate the reasonableness of the individual's acceptance of a high deductible insurance policy.

19. The method of claim 14, and further including the step of utilizing the results of the first method step to calculate the health care cost savings for an individual who, when provided with a health plan wellness regimen, follows the regimen.
